(19) United States
(12) Patent Application Publication
(10) Pub. No.: US 2012/0318088 A1
(43) Pub. Date: Dec. 20, 2012

(54) HYPOID GEAR

(76) Inventors: Hiromi Miyamura, Nagoya-shi (JP); Norihiro Mizoguchi, Toyota-shi (JP)

(21) Appl. No.: 13/579,948

(22) PCT Filed: Feb. 18, 2011
(86) PCT No.: PCT/IB2011/000308

§ 371 Date: Aug. 20, 2012

(30) Foreign Application Priority Data
Mar. 4, 2010 (JP) 2010-047804

(51) Int. Cl. F16H 1/18

(52) U.S. Cl. 74/417

(57) ABSTRACT

The multiple meshing teeth of a hypoid gear multiple are cut at a specified spiral angle. The pressure angle on a tooth convex surface (16a) of a ring gear (12) and on a tooth concave surface (18b) of the pinion (14), which contacts the tooth convex surface (16a), increases from a small diameter end toward a large diameter end. Accordingly, contact ratio between the tooth convex surface (16a) and the tooth concave surface (18b) may be increased. Furthermore, the pressure angle on a tooth concave surface (16b) of the ring gear (12) and on a tooth convex surface (18a) of the pinion (14), which contacts the concave tooth surface (16b), continuously decreases from the small diameter end toward the large diameter end. Accordingly, the contact ratio between the tooth concave surface (16b) and the tooth convex surface (18a) can be increased.

### BACKGROUND OF THE INVENTION

1. Field of the Invention

The present invention relates to a hypoid gear, and more particularly, to a technology that increases contact ratio without increasing the spiral angle of a meshing tooth.

2. Description of the Related Art

A hypoid gear generally includes a ring gear and a pinion, each of which has multiple teeth formed on a conical surface that are cut at a specified spiral angle and include a tooth convex surface and a tooth concave surface that are curved to follow the spiral. The ring gear meshes with the pinion to bring the tooth convex surfaces into contact with the tooth concave surfaces. Hypoid gears are generally used in the driveline of a vehicle, for example. It is common in the design of such hypoid gear that pressure angles on the tooth convex surface and the tooth concave surface are set to meet a specified strength requirement (Japanese Patent Application Publication No. 9-32908 (JP-A-9-32908)).

Although the larger pressure angle correlates with greater strength, it lowers the contact ratio. Thus, the spiral angle of the meshing tooth is increased to obtain the specified contact ratio. Meanwhile, the larger spiral angle produces a higher sliding velocity on the tooth surface and, as a result, increases mesh loss. In addition, greater bearing loss and reduced durability are followed that result from an increased thrust load.

FIGS. 6A and 6B illustrate the sliding velocity. FIG. 6A is a schematic view of a hypoid gear 100 in which a ring gear 102 with a larger diameter meshes with a pinion 104 with a smaller diameter in a crossed orientation. The ring gear 102 and the pinion 104 respectively have multiple teeth 106, 108 (only one each is shown in FIG. 6A) on a conical surface. Because the ring gear 102 meshes with the pinion 104 in the crossed orientation, an offset E is produced by an axial center Og of the ring gear 102 and an axial center Op of the pinion 104, and an angle ε is formed between generatrices of both cones that pass a contact point P. The angle ε is the difference between the spiral angle φg of the tooth 106 of the ring gear 102 and the spiral angle φp of the tooth 108 of the pinion 104 and produces a sliding velocity ΔV shown in the following equation (1). If the angle ε in the equation (1) is held constant, then the greater spiral angle φg correlates with the higher sliding velocity ΔV. The mesh loss Q is expressed in the equation (2) with a friction coefficient μ and a mesh load F, and is increased with the higher velocity ΔV. Thus, the greater mesh loss Q correlates with the larger spiral angles φg and φp. Here, vectors Vg and Vp in FIG. 6B are respectively moving velocities at the contact point P on the ring gear 102 and the pinion 104.

ΔV=Vn×(tan φp−tan φg)=Vn×[tan(φg+ε)−tan φg] (1)

Q=μ×ΔV×F (2)

### SUMMARY OF THE INVENTION

The present invention relates to a hypoid gear with multiple teeth that are curved at specified spiral angles, in which the contact ratio is increased without increasing the spiral angles of the teeth.

A first aspect of the present invention relates to a hypoid gear that includes a setup of a ring gear and a pinion. Each of the ring gear and the pinion has the multiple meshing teeth that are curved at a specified spiral angle on a conical surface.

At least one of tooth surfaces of the ring gear is characterized in that, in a second diagonal direction on the tooth surface that intersects with a concurrent contact line that defines a first diagonal direction on the tooth surface, a pressure angle is continuously increased from one end in a tooth-width direction, at which a second diagonal line is on a tooth root side, to the other end in the tooth-width direction.

The researches and studies by the present inventors revealed that, when the pressure angle is continuously changed in the tooth-width direction, a tilt angle θ of the concurrent contact line is changed, and consequently, the contact ratio is changed. As in the first aspect, the contact ratio of the meshing tooth of the ring gear can be increased when the pressure angle is continuously increased from one end in a tooth-width direction, at which a second diagonal line that intersects with a concurrent contact line that determines a direction of a first diagonal line on the tooth surface is on a tooth root side, to the other end in the tooth-width. Accordingly, the contact ratio can be increased without increasing the spiral angle of the meshing tooth, and the contact ratio can be increased while greater meshing loss, which is caused by a higher sliding velocity on the tooth surface, greater bearing loss, which is caused by a greater thrust load, and lowered durability are prevented.

A second aspect of the present invention relates to a hypoid gear that includes a setup of a ring gear and a pinion. Each of the ring gear and the pinion has multiple meshing teeth that are curved at a specified spiral angle on a conical surface. At least one of tooth surfaces of the meshing tooth of the pinion is characterized in that, in a second diagonal direction on the tooth surface that intersects with a concurrent contact line that defines a first diagonal direction on the tooth surface, a pressure angle is continuously decreased from one end in a tooth-width direction, at which a second diagonal line is on a tooth root side, to the other end in the tooth-width direction.

The second aspect relates to a tooth shape of the pinion, which is designed to correspond with a tooth shape of the ring gear in the first aspect. More specifically, the pressure angle is continuously decreased from one end in a tooth-width direction, at which a second diagonal line that intersects with a concurrent contact line that determines a direction of a first diagonal line on the tooth surface is on a tooth root side, to the other end in the tooth-width direction. Accordingly, the pinion can be meshed appropriately with the ring gear of the first aspect for power transmission, and thus can achieve the same effects as those of the first aspect.

In the third aspect, a hypoid gear includes a ring gear paired with a pinion, each of which has multiple meshing teeth on a conical surface that are cut at a specified spiral angle and includes a tooth convex surface and a tooth concave surface that are curved at an angle corresponding to the spiral angle. The ring gear meshes with the pinion to make the tooth convex surface contact with the tooth concave surface. In the hypoid gear, the pressure angle on the tooth convex surface of the ring gear continuously increases from the small diameter end to the large diameter end.

The third aspect relates to the tooth convex surface of the ring gear, whose contact ratio can be increased by continuously increasing the pressure angle from the small diameter end to the large diameter end. This third aspect substantially corresponds to the first embodiment of the first aspect, and thus can achieve the same effects as those of the first aspect.

In addition, in the hypoid gear of the third aspect, the pressure angle on the tooth concave surface of the pinion that contacts the tooth convex surface of the ring gear may continuously be increased from the small diameter end to the large diameter end.

Accordingly, the tooth concave surface of the pinion that contacts the tooth convex surface of the ring gear is designed to correspond with the tooth convex surface of the ring gear, and the pressure angle can continuously be increased from the small diameter end toward the large diameter end. Therefore, the tooth concave surface of the pinion can appropriately contact the tooth convex surface of the ring gear of the third aspect for power transmission, and can achieve the same effects as those of the third aspect.

The fourth aspect relates to a hypoid gear that includes a setup of a ring gear and a pinion, each of which has multiple meshing teeth on a conical surface that are cut at a specified spiral angle and include a tooth convex surface and a tooth concave surface that are curved at an angle corresponding to the spiral angle. In the hypoid gear, the pressure angle on the tooth concave surface of the ring gear is continuously decreased from the small diameter end toward the large diameter end.

The fourth aspect relates to the tooth concave surface of the ring gear, whose contact ratio can be increased by continuously decreasing the pressure angle from the small diameter end toward the large diameter end. The fourth aspect substantially corresponds to the first embodiment of the first aspect, and thus can achieve the same effects as those of the first aspect.

Also, in the hypoid gear of the fourth aspect, the pressure angle on the tooth convex surface of the pinion that contacts the tooth concave surface of the ring gear may be continuously decreased from the small diameter end toward the large diameter end.

Accordingly, the tooth convex surface of the pinion that contacts the tooth concave surface of the ring gear is designed to correspond with the tooth concave surface of the ring gear, and the pressure angle on the tooth convex surface of the pinion can continuously be decreased from the small diameter end toward the large diameter end. Therefore, the tooth convex surface of the pinion can appropriately contact the concave tooth surface of the ring gear of the fourth aspect for power transmission, and can achieve the same effects as those of the fourth aspect.

The fifth aspect relates to a hypoid gear that includes a setup of a ring gear and a pinion, each of which has multiple meshing teeth on a conical surface that are cut at a specified spiral angle and include a tooth convex surface and a tooth concave surface that are curved at an angle corresponding to the spiral angle. The ring gear meshes with the pinion to make the tooth convex surface contact with the tooth convex surface. In the hypoid gear, a shape of the tooth convex surface of the ring gear is designed such that a tilt angle θ of a concurrent contact line is continuously increased from the small diameter end toward the large diameter end. The above shape of the tooth convex surface is not a micro shape such as crowning and bias but a macro shape. The same applies to the shape of the following tooth surface.

The fifth aspect relates to the tooth convex surface of the ring gear whose contact ratio can be increased by continuously increasing the tilt angle θ of the concurrent contact line from the small diameter end toward the large diameter end, and thus can achieve the same effects as those of the first aspect.

Also, in the hypoid gear of the fifth aspect, a shape of the tooth concave surface of the pinion that contacts the tooth convex surface of the ring gear may be designed such that the tilt angle θ of the concurrent contact line is continuously increased from the small diameter end toward the large diameter end.

Accordingly, the concave tooth surface of the pinion that contacts the tooth convex surface of the ring gear is designed to correspond with the tooth convex surface of the ring gear, and the tilt angle θ of the concurrent contact line can continuously be increased from the small diameter end toward the large diameter end. Therefore, the concave tooth surface of the pinion can appropriately contact the tooth convex surface of the ring gear of the fifth aspect for power transmission, and can achieve the same effects as those of the fifth aspect.

The sixth aspect relates to a hypoid gear that includes a setup of a ring gear and a pinion, each of which has multiple meshing teeth on a conical surface that are cut at a specified spiral angle and include a tooth convex surface and a tooth concave surface that are curved at an angle corresponding to the spiral angle. The ring gear and the pinion mesh with each other to make the tooth concave surfaces contact the tooth convex surfaces. In the hypoid gear, a shape of the tooth concave surface of the ring gear is designed such that the tilt angle θ of the concurrent contact line is continuously decreased from the small diameter end toward the large diameter end.

The sixth aspect relates to the tooth concave surface of the ring gear whose contact ratio can be increased by continuously decreasing the tilt angle θ of the concurrent contact line from the small diameter end toward the large diameter end, and thus can achieve the same effects as those of the first aspect.

Also, in the hypoid gear of the sixth aspect, a shape of the tooth convex surface of the pinion that contacts the tooth concave surface of the ring gear may be designed such that the tilt angle θ of the concurrent contact line is continuously decreased from the small diameter end toward the large diameter end.

Accordingly, the tooth convex surface of the pinion that contacts the tooth concave surface of the ring gear of the six aspect is designed to correspond with the tooth concave surface of the ring gear, and the tilt angle θ of the concurrent contact line can continuously be decreased from the toe end toward the heel end. Therefore, the tooth convex surface of the pinion can appropriately contact the tooth concave surface of the ring gear of the sixth aspect for power transmission, and can achieve the same effects as those of the sixth aspect.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a perspective view of a hypoid gear according to the present invention;

FIGS. 2A and 2B respectively show a tooth convex surface and a tooth concave surface with the surfaces being flattened, and also illustrate changes in the pressure angle and the tilt angle θ of a concurrent contact line;

FIGS. 3A and 3B are perspective views that show stereoscopic shapes of the tooth convex surface and the tooth concave surface of the ring gear in FIGS. 2A and 2B;

FIGS. 4A and 4B respectively show the tooth convex surface and the tooth concave surface with the surfaces being flattened, and also illustrate changes in the pressure angle and the tilt angle θ of the concurrent contact line;

FIGS. 5A and 5B show the tooth surfaces of the ring gear and a pinion of the hypoid gear, and illustrate changes in the pressure angle and the tilt angle θ of the concurrent contact line to increase the contact ratio, with reference to a tilted direction of the concurrent contact line; and

FIGS. 6A and 6B illustrates the increase of a sliding velocity ΔV with larger spiral angles φg and φp of meshed teeth of the hypoid gear.

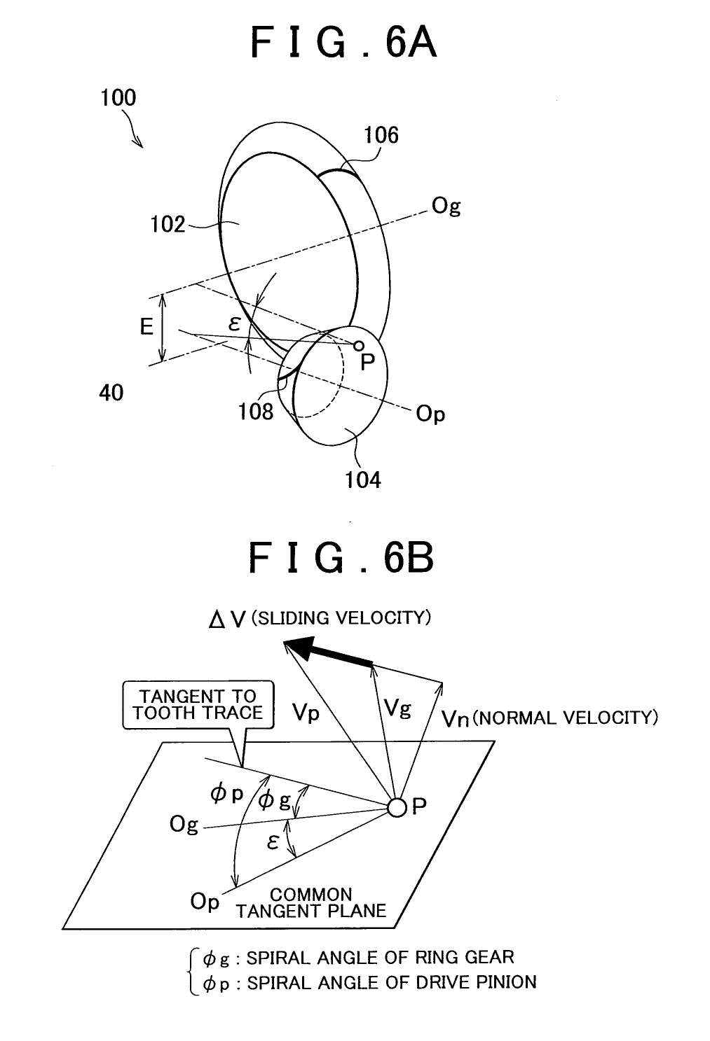

### DETAILED DESCRIPTION OF EMBODIMENTS

The present invention is applied to a hypoid gear with an offset between the spiral angle φg of the teeth of a ring gear and the spiral angle φp of the teeth of a pinion, in which the spiral angle φp is larger than the spiral angle φg. However, the present invention may also be applied to a hypoid gear with an offset between the spiral angle φg of the teeth of the ring gear and the spiral angle φp of the teeth of the pinion in which the spiral angle φp is smaller than the spiral angle φg. Helical directions of the meshing teeth of the ring gear and the pinion oppose each other, and the helical directions are determined as appropriate. The spiral angles φg and φp may be constant over the lengths of the meshing teeth in a tooth-width direction, or they may vary continuously like a circular arc meshing teeth, for example.

A first embodiment of the present invention relates to the ring gear, and a second embodiment of the present invention relates to the pinion. These embodiments may be implemented separately. However, when the embodiments are actually used as a hypoid gear, the ring gear and the pinion are combined, and the embodiments are adopted to teeth surfaces that contact each other. The teeth include a tooth convex surface and a tooth concave surface. However, the present invention is not necessarily applied to both tooth surfaces of the ring gear or the pinion. For example, the present invention may be applied to the tooth convex surface of the ring gear and the tooth concave surface of the pinion, or to the tooth concave surface of the ring gear and the tooth convex surface of pinion.

In the first embodiment, an increase and decrease of a pressure angle are determined with reference to a second diagonal direction of the tooth surfaces that intersects with a concurrent contact line that defines a first diagonal direction of the tooth surfaces. Meanwhile, the substantially same increase and decrease of the pressure angle as above can be determined, with reference to the first diagonal direction that is in the same tilt direction as the concurrent contact line. It may be determined that the pressure angle is continuously increased from one end in a tooth-width direction, at which the first diagonal line is on a tooth apex side, to the other end in the tooth-width direction. This determination is also included in a technical scope of the first embodiment. The same also applies to the second embodiment.

Although the pressure angle is determined in the first and second embodiments, an increase and decrease of a tilt angle θ of the concurrent contact line may also be determined. More specifically, on at least one of the tooth surfaces of the meshing tooth of the ring gear, the tilt angle θ of the concurrent contact line may be continuously increased from one end in a tooth-width direction, at which a second diagonal line that intersects with a concurrent contact line that determines a direction of a first diagonal line on the tooth surface is on a tooth root side, to the other end in the tooth-width direction. More specifically, on at least one of the tooth surfaces of the meshing tooth of the pinion, the tilt angle θ of the concurrent contact line may be continuously decreased from one end in a tooth-width direction, at which a second diagonal line that intersects with a concurrent contact line that determines a direction of a first diagonal line on the tooth surface is on a tooth root side, to the other end in the tooth-width direction. The increase and decrease of the pressure angle and those of the tilt angle θ of the concurrent contact line are linearly changed at a constant rate of change in the tooth-width direction, for example.

The present invention may be appropriately applied to a hypoid gear in which the ring gear provided in a differential gear train that transmits driving power to the right and left wheels of a vehicle is rotatably driven by the pinion. However, the present invention may also be applied to the hypoid gear that is used in another driveline of a vehicle or else.

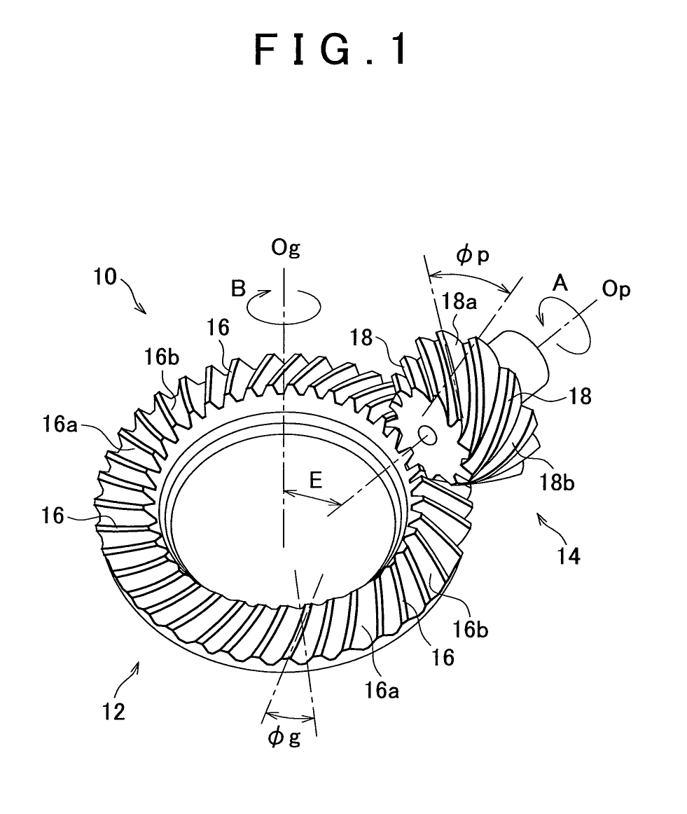

An embodiment of the present invention is described in detail below with reference to the drawings. FIG. 1 is a perspective view of an example of hypoid gear 10 to which the present invention is applied and that includes a ring gear 12 with a large diameter and a pinion 14 with a small diameter. The hypoid gear 10 is appropriately used when the ring gear 12 that is provided in a differential gear train for providing the driving power to the right and left rear wheels of the vehicle, for example, is rotatably driven by the pinion 14, which is connected to a propeller shaft. While multiple meshing teeth 16 that are curved clockwise at a specified spiral angle φg are provided on a conical surface of the ring gear 12, multiple meshing teeth 18 that are curved counter-clockwise at the specified spiral angle φp are provided on a conical surface of the pinion 14. These meshing teeth 16 and 18 are generally arc shaped when viewed from the top side of the conical surfaces, and respectively include arc-shaped tooth convex surfaces 16a and 18a and tooth concave surfaces 16b and 18b on both outer peripheral and inner peripheral sides. An axial center Og of the ring gear 12 and an axial center Op of the pinion 14 are in the crossed orientation and are offset by a distance E. In this embodiment, the axial center Op of the pinion is offset in a direction where the spiral angle φp of the meshing teeth 18 of the pinion 14 is larger than the spiral angle φg of the meshing teeth 16 of the ring gear 12 (in a lower right direction in FIG. 1). Although the spiral angles φg and φp are continuously changed over the lengths of the meshing teeth 16 and 18 in the tooth-width direction, the spiral angles φp and φg described here are the spiral angles at a mid point in the tooth-width direction (central spiral angle). The spiral angle φg is about 35° and the spiral angle φp is 50°, for example.

In such hypoid gear 10, when a vehicle is accelerated to drive forward, the pinion 14 is rotatably driven in the direction show by the arrow A so that the tooth concave surface 18b of the meshing tooth 18 of the pinion 14 meshes with the tooth convex surface 16a of the meshing tooth 16 of the ring gear 12, and consequently, the driving force rotates the ring gear 12 in the direction shown by the arrow B. When the vehicle coasts in the forward direction, the ring gear 12 is rotatably driven in the direction shown by the arrow B so that the tooth concave surface 16b of the meshing tooth 16 of the ring gear 12 meshes with the tooth convex surface 18a of the meshing tooth 18 of the pinion 14, and consequently, the pinion 14 is rotatably driven in the direction shown by the arrow A. In contrast, although not used frequently, the pinion 14 is rotatably driven in the direction opposite that shown by the arrow A when the vehicle accelerates in reverse. Accordingly, the tooth convex surface 18a of the meshing tooth 18 of the pinion 14 meshes with the tooth concave surface 16b of the meshing tooth 16 of the ring gear 12, and consequently, the driving force rotates the ring gear 12 in the direction opposite that shown by the arrow B. When the vehicle coasts in the reverse direction, as the ring gear 12 is rotatably driven in the opposite direction of the arrow B, the tooth convex surface 16a of the meshing tooth 16 of the ring gear 12 meshes with the tooth concave surface 18b of the meshing tooth 18 of the pinion 14, and consequently, the pinion 14 is rotatably driven in the direction opposite that shown by the arrow A.

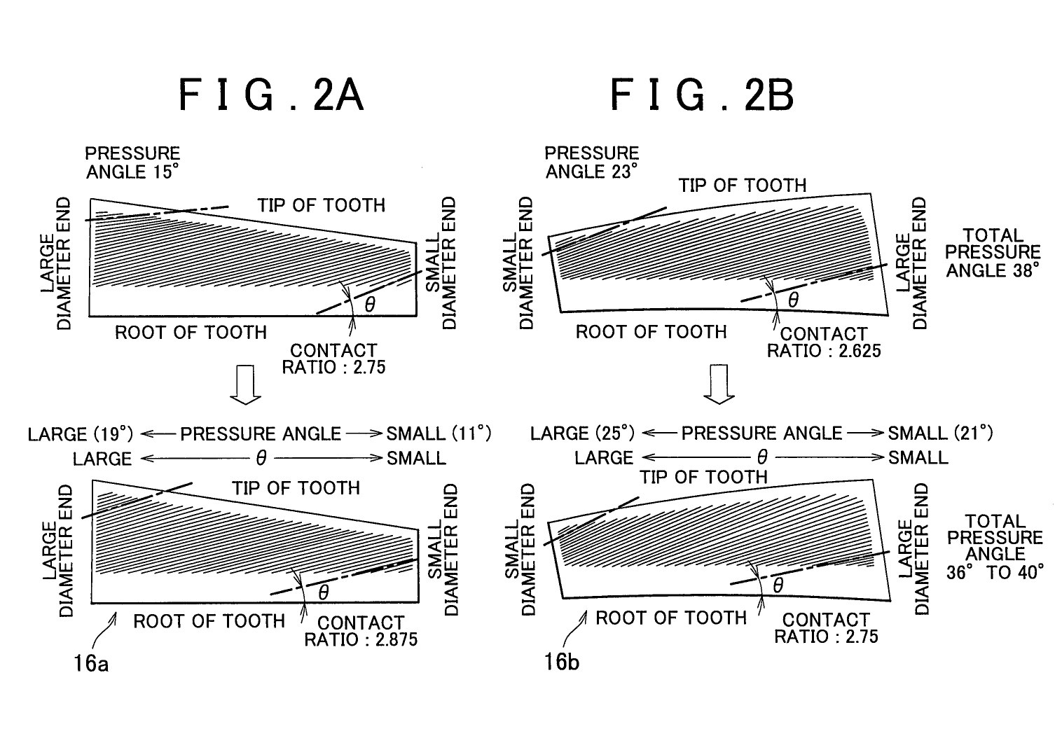

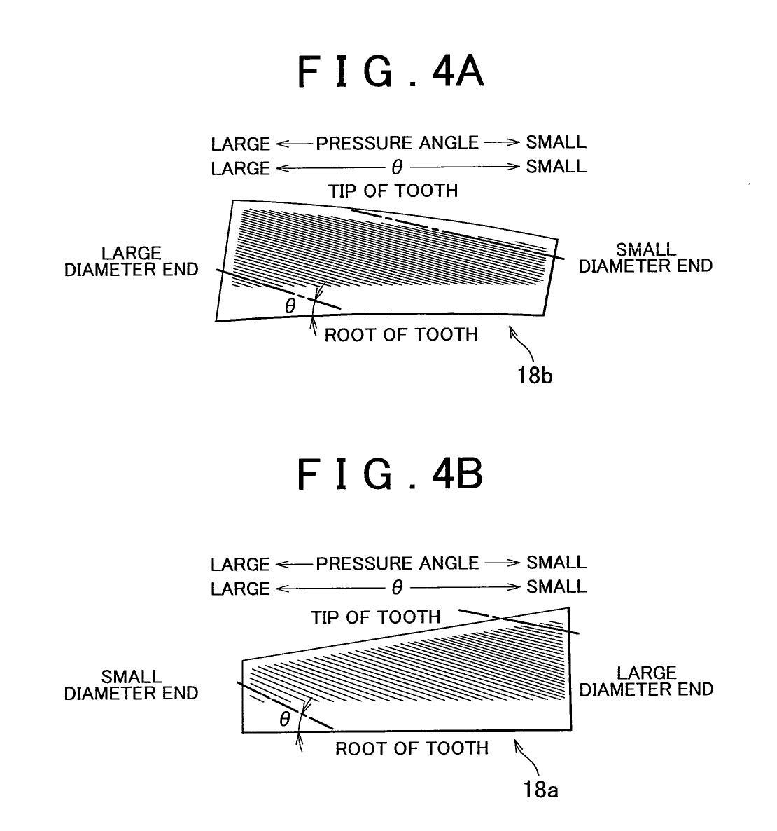

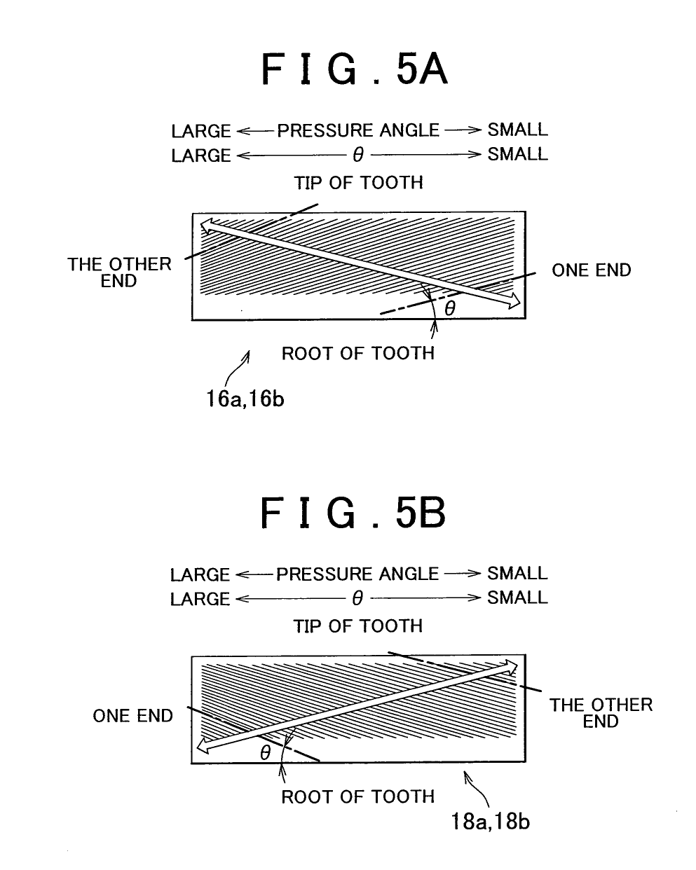

FIGS. 2A and 2B is a view that specifically illustrates the tooth convex surface 16a and the tooth concave surface 16b of the ring gear 12 with the tooth convex surface 16a and the tooth concave surface 16b being flattened. Thin diagonal lines in each figure schematically represent the concurrent contact lines (strictly, curved lines). FIGS. 2A and 2B show the concurrent contact lines of the meshing tooth 16 for a pitch that is broken up into 16 segmentations, and a quotient of the number of the concurrent contact lines and 16 corresponds to the contact ratio. The same applies to FIGS. 4A and 4B as well as to FIGS. 5A and 5B.

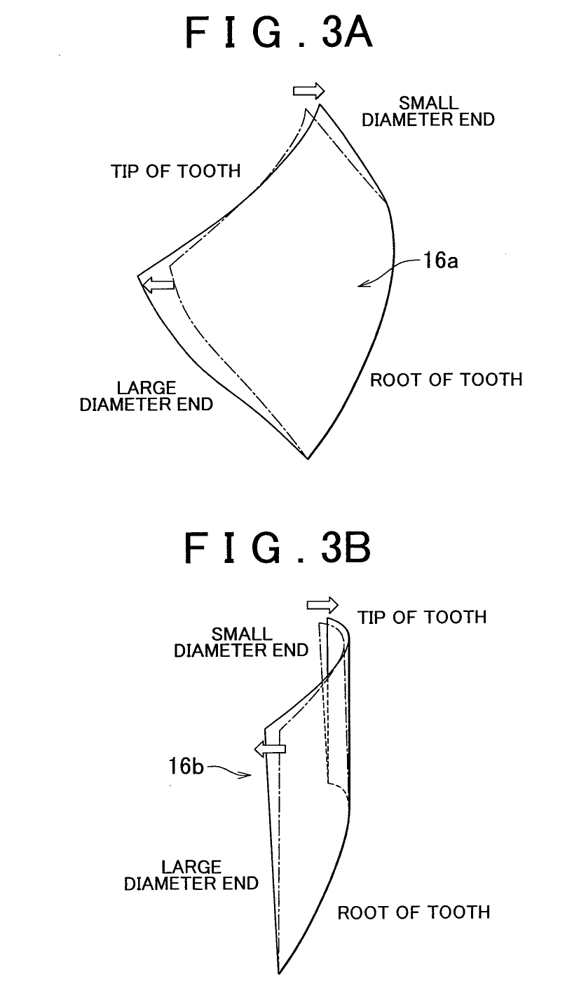

FIG. 2A shows the tooth convex surface 16a. The upper figure of FIG. 2A shows the tooth convex surface 16a of the related art where the pressure angle is a constant 15°. The lower figure of FIG. 2A shows the tooth convex surface 16a of this embodiment where the pressure angle is continuously increased from 11° to 19° as a measuring point of the angle moves from a small diameter end to a large diameter end with 15° at the mid point in the tooth-width direction being therebetween. In this embodiment, the pressure angle increases linearly at a constant rate in the tooth-width direction. Because the pressure angle changes continuously as described above, the tilt angle θ of the concurrent contact line is continuously increased from the small diameter end toward the large diameter end. The contact ratio is calculated in simulations in which the pressure angle remains constant and in simulations in which the pressure angle changes continuously. If the pressure angle is constant, the contact ratio was 2.75. If the pressure angle increases continuously as described above, the contact ratio is 2.875, which is an increase of 0.125. FIG. 3A is a perspective view in which a solid line shows the stereoscopic shape of the tooth convex surface 16a and a long and short dashed line shows the tooth convex surface 16a whose pressure angle is a constant 15°.

FIG. 2B shows the tooth concave surface 16b. The upper figure of FIG. 2B shows the tooth convex surface 16b of the related art where the pressure angle is a constant 23°. The lower figure of FIG. 2B shows the tooth concave surface 16b of this embodiment where the pressure angle is continuously decreased from 25° to 21° as a measuring point of the angle moves from a small diameter end to a large diameter end with 23° at the mid point in the tooth-width direction being therebetween. In this embodiment, the pressure angle decreases linearly at a constant rate in the tooth-width direction. Because the pressure angle continuously changes as described above, the tilt angle θ of the current contact line is continuously decreased from the small diameter end toward the large diameter end. The contact ratio was calculated in simulations for a case where the pressure angle remains constant and for a case where the pressure angle is continuously changed, as described above. When the pressure angle is constant, the contact ratio was 2.625. When the pressure angle decreases continuously as described above, the contact ratio was 2.75, which is an increase of 0.125. FIG. 3B is a perspective view in which a solid line shows the stereoscopic shape of the tooth concave surface 16b and a long and short dashed line shows the tooth concave surface 16b whose pressure angle is a constant 23°.

The pressure angle change of the tooth convex surface 16a and the tooth concave surface 16b with respect to the tilt directions of the concurrent contact lines on the tooth surfaces denote the same tendency as shown in FIG. 5A. More specifically, as shown by the hollow white arrow in FIG. 5A, when a diagonal line that is tilted in an opposite direction from the tilt direction of the concurrent contact line on the tooth surface is defined, the pressure angle is continuously increased from one end in the tooth-width direction, at which the diagonal line is on the tooth root side, to the other end in the tooth width direction. A first diagonal direction is tilted in the same direction as the tilt direction of the concurrent contact line. A second diagonal direction is not tilted in the same manner as the first diagonal direction, that is, a diagonal direction that is shown with the hollow white line. In addition, the tilt angle θ of the concurrent contact line continuously increases from the above one end to the other end. In the tooth convex surface 16a, the small diameter end is the one end while the large diameter end is the other end. In the tooth concave surface 16b, the large diameter end is the one end while the small diameter end is the other end.

However, the contact ratio is determined by the relationship with the tooth surface of the pinion 14. The shape of tooth concave surface 18b of the pinion 14 complements the tooth convex surface 16a of the ring gear 12. The shape of tooth convex surface 18a of the pinion 14 complements the tooth concave surface 16b of the ring gear 12. More specifically, on the tooth concave surface 18b, the pressure angle continuously increases from the small diameter end to the large diameter end. At the same time, the tilt angle θ of the concurrent contact line likewise continuously increases from the small diameter end to the large diameter end. In this embodiment, the pressure angle increases linearly at a constant rate in the tooth-width direction. On the tooth convex surface 18a, the pressure angle continuously decreases from the small diameter end to the large diameter end. At the same time, the tilt angle θ of the concurrent contact line also decreases continuously from the small diameter end to the large diameter end. In this embodiment, the pressure angle decreases linearly at a constant rate in the tooth-width direction.

The pressure angle change of the tooth convex surface 18a and the tooth concave surface 18b of the pinion 14 with the tilt directions of the concurrent contact lines on the tooth surfaces as references denote the same tendency as shown in FIG. 5B. More specifically, as shown by the hollow white arrow in FIG. 5B, when a diagonal line that is tilted in an opposite direction from the tilt direction of the concurrent contact line on the tooth surface is defined, the pressure angle continuously decreases from one end in the tooth-width direction, at which the diagonal line is on the tooth root side, to the other end in the tooth width direction. A first diagonal direction is tilted in the same direction as the tilt direction of the concurrent contact line. A second diagonal direction is not tilted in the same manner as the first diagonal direction, that is, tilted as shown with the hollow white line. In addition, the tilt angle θ of the concurrent contact line continuously decreases from the above one end to the other end. In the tooth convex surface 18a, the small diameter end is the one end while the large diameter end is the other end. In the tooth concave surface 18b, the large diameter end is the one end while the small diameter end is the other end.

As described above, in the hypoid gear 10 of this embodiment, the pressure angle or the tilt angle θ of the concurrent contact line on the tooth convex surface 16a of the ring gear 12 is continuously increased from the small diameter end to the large diameter end. Also, the pressure angle or the tilt angle θ of the concurrent contact line on the tooth concave surface 18b of the pinion 14 that contacts the tooth convex surface 16a is continuously increased from the small diameter end to the large diameter end. Accordingly, the contact ratio between the tooth convex surface 16a and the tooth concave surface 18b can be increased. More specifically, the contact ratio may be increased without increasing the spiral angles φg and φp of the meshing tooth 16 and 18. In addition, the contact ratio between the tooth convex surface 16a of the ring gear 12 and the tooth concave surface 18b of the pinion 14 may be increased while avoiding increases in meshing loss, which is caused by a higher sliding velocity on the tooth surface, bearing loss and a decrease in durability, which are cause by a greater thrust load. Accordingly, it is possible to reduce noise, vibration, and the like that are produced when the vehicle is accelerated forward and the tooth convex surface 16a of the ring gear 12 meshes with the tooth concave surface 18b of the pinion 14.

The pressure angle or the tilt angle θ of the concurrent contact line on the tooth concave surface 16b of the ring gear 12 is continuously decreased from the small diameter end to the large diameter end. Also, the pressure angle or the tilt angle θ of the concurrent contact line on the tooth convex surface 18a of the pinion 14 that contacts the tooth concave surface 16b continuously decreases from the small diameter end to the large diameter end. Accordingly, the contact ratio between the tooth concave surface 16b and the tooth convex surface 18a may be increased. More specifically, the contact ratio may be increased without increasing the spiral angles φg and φp of the meshing tooth 16 and 18. In addition, the contact ratio between the tooth concave surface 16b of the ring gear 12 and the tooth convex surface 18a of the pinion 14 may be increased without increasing meshing loss, which is caused by the higher sliding velocity on the tooth surfaces, as well as avoiding increases in bearing loss and decreases in durability, which are cause by the greater thrust load. Accordingly, it is possible to reduce noise, vibration, and the like that are produced when the vehicle coasts forward and the tooth concave surface 16b of the ring gear 12 is meshed with the tooth convex surface 18a of the pinion 14.

Although the embodiment of the present invention has been described in detail with reference to the drawings, the embodiment is merely illustrative, and the present invention may be modified and improved in various ways on the basis of the knowledge of those skilled in the art.

1. A hypoid gear comprising:
a ring gear and a pinion, each of which has multiple meshing teeth formed over a conical surface that are cut at a specified spiral angle,
wherein on at least one of tooth surfaces of the meshing tooth of the ring gear, a pressure angle is continuously increased from one end in a tooth-width direction, at which a second diagonal line is on a tooth root side, to the other end in the tooth-width direction, with said second diagonal line being a diagonal line of the tooth surface intersecting a first diagonal line of the tooth surface defined by a concurrent contact line on the tooth surface.

2. A hypoid gear comprising:
a ring gear and a pinion, each of which has multiple meshing teeth formed over a conical surface that are cut at a specified spiral angle,
wherein on at least one of tooth surfaces of the meshing tooth of the pinion, a pressure angle is continuously decreased from one end in a tooth-width direction, at which a second diagonal line is on a tooth root side, to the other end in the tooth-width direction, with said second diagonal line being a diagonal line of the tooth surface intersecting a first diagonal line of the tooth surface defined by a concurrent contact line on the tooth surface.

3. The hypoid gear according to claim 8, wherein
a pressure angle on the tooth convex surface of the ring gear is continuously increased from the small diameter end to the large diameter end.

4. The hypoid gear according to claim 3, wherein a pressure angle on the tooth concave surface of the pinion that contacts the tooth convex surface of the ring gear is continuously increased from the small diameter end to the large diameter end.

5. The hypoid gear according to claim 10, wherein
a pressure angle on the tooth concave surface of the ring gear is continuously decreased from the small diameter end toward the large diameter end.

6. The hypoid gear according to claim 5, wherein a pressure angle on the tooth convex surface of the pinion that contacts the tooth concave surface of the ring gear is continuously decreased from the small diameter end toward the large diameter end.

7. A hypoid gear comprising:
a ring gear and a pinion, each of which has multiple meshing teeth formed over a conical surface that are cut at a specified spiral angle and that include a tooth convex surface and a tooth concave surface that are curved at an angle corresponding to the spiral angle, and in which the ring gear meshes with the pinion so that the tooth convex surfaces contact the tooth concave surfaces,
wherein a tooth convex surface of the ring gear is shaped so that a tilt angle of a concurrent contact line is continuously increased from a small diameter end toward a large diameter end.

8. The hypoid gear according to claim 7, wherein a tooth concave surface of the pinion that contacts a tooth convex surface of the ring gear is shaped so that the tilt angle of the concurrent contact line is continuously increased from the small diameter end toward the large diameter end.

9. A hypoid gear comprising:
a ring gear and a pinion, each of which has multiple meshing teeth formed over a conical surface that are cut at a specified spiral angle and that include a tooth convex surface and a tooth concave surface that are curved at an angle corresponding to the spiral angle, and in which the ring gear meshes with the pinion so that the tooth convex surfaces contact the tooth concave surfaces,
wherein a tooth concave surface of the ring gear is shaped so that a tilt angle of a concurrent contact line is continuously decreased from a small diameter end toward a large diameter end.

10. The hypoid gear according to claim 9, wherein a tooth convex surface of the pinion that contacts the tooth concave surface of the ring gear is shaped so that the tilt angle of the concurrent contact line is continuously decreased from the small diameter end toward the large diameter end.
